(19) United States
(12) Patent Application Publication
(10) Pub. No.: US 2025/0317261 A1
(43) Pub. Date: Oct. 9, 2025

(54) INITIAL ACCESS FOR NB-IOT OVER NTN FOR TDD SYSTEMS

(71) Applicant: QUALCOMM Incorporated, San Diego, CA (US)

(72) Inventors: Ayan SENGUPTA, San Diego, CA (US); Alberto RICO ALVARINO, San Diego, CA (US); Peter GAAL, San Diego, CA (US)

(21) Appl. No.: 18/991,289

(22) Filed: Dec. 20, 2024

Related U.S. Application Data
(60) Provisional application No. 63/573,996, filed on Apr. 3, 2024.

(51) Int. Cl. H04L 5/14; H04W 72/0446; H04W 84/06

(52) U.S. Cl. CPC H04L 5/14; H04W 72/0446; H04W 84/06

(57) ABSTRACT

The apparatus may be a wireless device configured to determine a time division duplex (TDD) frame repetition unit for a non-terrestrial network (NTN) cell, wherein the TDD frame repetition unit specifies a TDD frame structure spanning multiple radio frames within a repetition period, monitor, based on the TDD frame repetition unit, at least one signal, of a set of signals, associated with cell acquisition for Narrowband-Internet of Things (NB-IoT) over the NTN cell, and communicate with the NTN cell based on the at least one monitored signal associated with the cell acquisition.

### CROSS REFERENCE TO RELATED APPLICATION(S)

This application claims the benefit of and priority to U.S. Provisional Application Ser. No. 63/573,996, entitled “INITIAL ACCESS FOR NB-IoT OVER NTN FOR TDD SYSTEMS” and filed on Apr. 3, 2024, which is expressly incorporated by reference herein in its entirety.

### TECHNICAL FIELD

The present disclosure relates generally to communication systems, and more particularly, to wireless communication associated with a non-terrestrial network (NTN).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device configured to determine a time division duplex (TDD) frame repetition unit for a non-terrestrial network (NTN) cell, where the TDD frame repetition unit specifies a TDD frame structure spanning multiple radio frames within a repetition period, monitor, based on the TDD frame repetition unit, at least one signal, of a set of signals, associated with cell acquisition for Narrowband-Internet of Things (NB-IoT) over the NTN cell, and communicate with the NTN cell based on the at least one monitored signal associated with the cell acquisition.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating a TDD frame repetition unit in accordance with some aspects of the disclosure.

FIG. 5 is a diagram illustrating an example NB-IoT pattern in accordance with some aspects of the disclosure.

FIG. 6 is a diagram illustrating a set of narrowband physical broadcast channel (NPBCH) sub-block repetitions in accordance with some aspects of the disclosure.

FIG. 7 is a set of diagrams illustrating a first and second configuration for frame numbering in accordance with some aspects of the disclosure.

FIG. 8 is a diagram illustrating a configuration for frame numbering in accordance with some aspects of the disclosure.

FIG. 9 is a call flow diagram illustrating a method of wireless communication for NB-IoT over NTN in accordance with some aspects of the disclosure.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

### DETAILED DESCRIPTION

In some aspects of satellite-based wireless communication, satellite-based (e.g., NTN) systems are predicated on a frequency division duplex (FDD) setup. The FDD, in some aspects, may be used instead of a TDD because of the challenges associated with designing a TDD system that can handle timing offsets due to large delays associated with satellite-based system (or NTN). In some aspects, a small TDD granularity (e.g., short time periods between switching between UL and DL such as at the level of slots) is small (e.g., at the level of slots) may amplify the challenges associated with designing the TDD system. Accordingly, some existing NTN systems function on a “large granularity” TDD pattern, e.g., a 35 ms period for UL, followed by a 35 ms period for DL. However, in some aspects, NB-IoT (e.g., associated with small data communications, such as short message service (SMS), or low data-rate voice) may not currently be compatible with existing NTN systems and/or deployments.

Various aspects relate generally to a custom-designed signal mapping approach to allow NB-IoT over existing large-granularity NTN TDD systems. Some aspects more specifically relate to initial access and/or cell acquisition design aspects for NB-IoT over existing large-granularity NTN TDD systems. In some examples, a wireless device may be configured to determine a TDD frame repetition unit for a NTN cell, where the TDD frame repetition unit specifies a TDD frame structure spanning multiple radio frames within a repetition period, monitor, based on the TDD frame repetition unit, at least one signal, of a set of signals, associated with cell acquisition for NB-IoT over the NTN cell, and communicate with the NTN cell based on the at least one monitored signal associated with the cell acquisition.

Particular aspects of the subject matter described in this disclosure can be implemented to realize one or more of the following potential advantages. In some examples, by deploying and/or implementing a custom-designed signal mapping for initial access and/or cell acquisition associated with NB-IoT, the described techniques can be used to allow NB-IoT over existing large-granularity NTN TDD systems.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

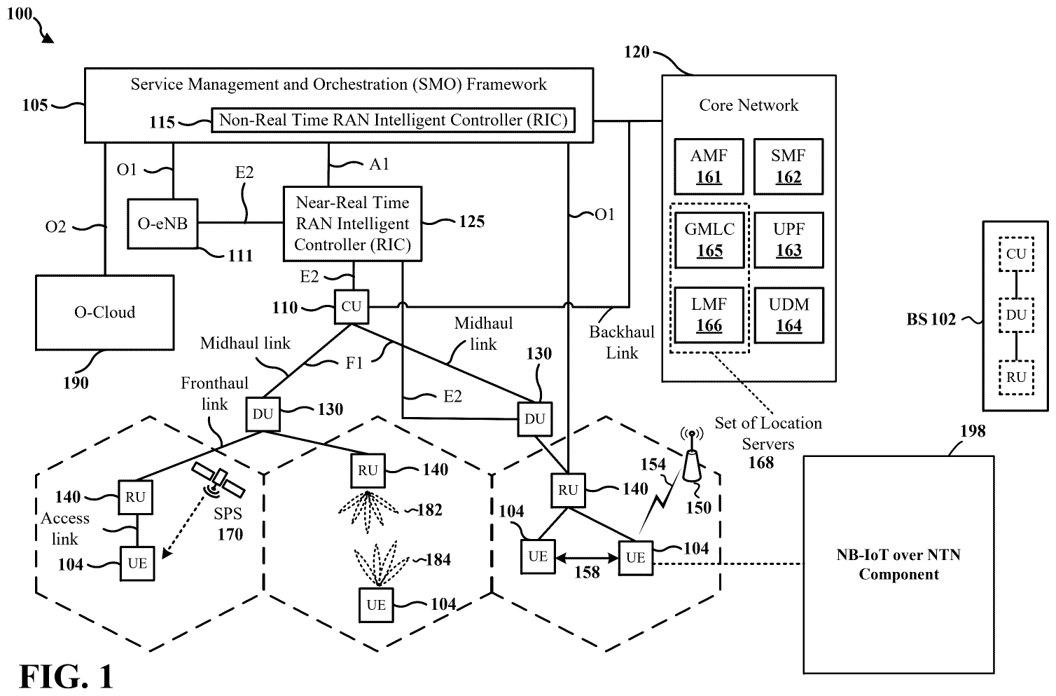

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a NB-IoT over NTN component 198 that may be configured to determine a TDD frame repetition unit for a NTN cell, where the TDD frame repetition unit specifies a TDD frame structure spanning multiple radio frames within a repetition period, monitor, based on the TDD frame repetition unit, at least one signal, of a set of signals, associated with cell acquisition for NB-IoT over the NTN cell, and communicate with the NTN cell based on the at least one monitored signal associated with the cell acquisition. Although the following description may be focused on 5G NR, the concepts described herein may be applicable to other similar areas, such as LTE, LTE-A, CDMA, GSM, and other wireless technologies.

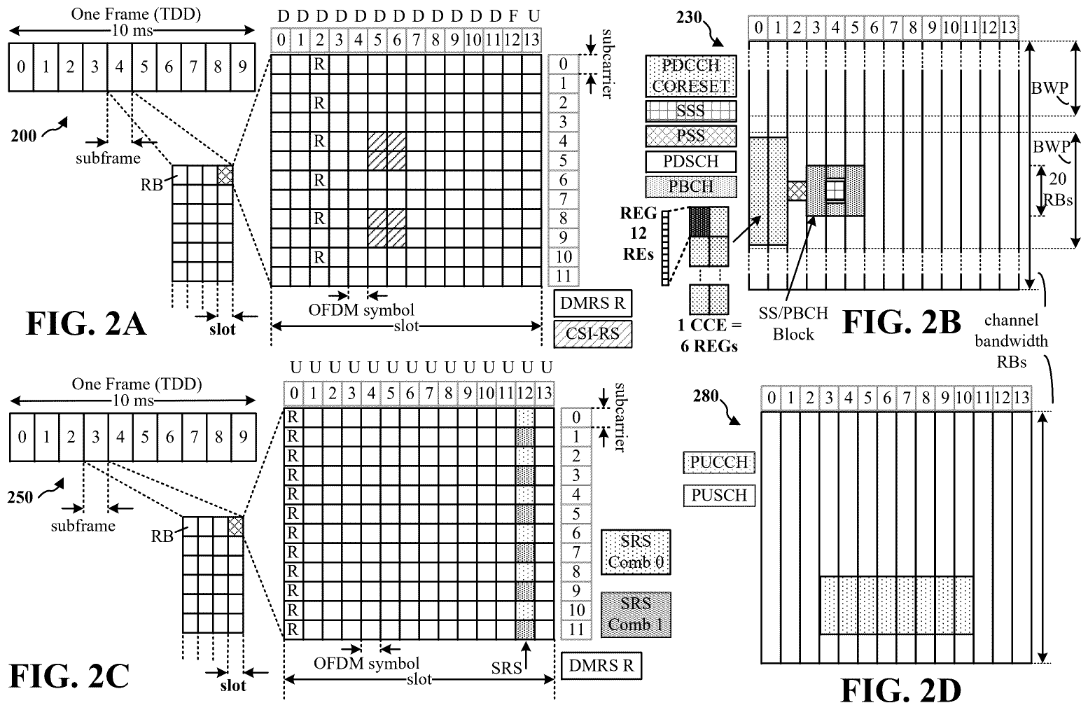

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

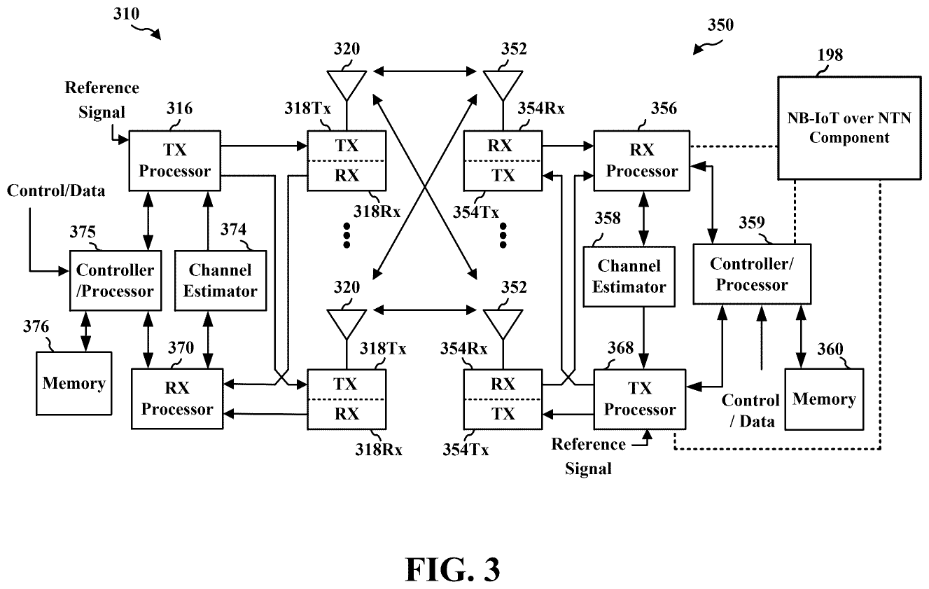

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the NB-IoT over NTN component 198 of FIG. 1.

In some aspects of satellite-based wireless communication, satellite-based (e.g., NTN) systems are predicated on a frequency division duplex (FDD) setup. The FDD, in some aspects, may be used instead of a TDD because of the challenges associated with designing a TDD system that can handle timing offsets due to large delays associated with satellite-based system (or NTN). In some aspects, a small TDD granularity (e.g., short time periods between switching between UL and DL such as at the level of slots) is small (e.g., at the level of slots) may amplify the challenges associated with designing the TDD system. Accordingly, some existing NTN systems function on a “large granularity” TDD pattern, e.g., a 35 ms period for UL, followed by a 35 ms period for DL. However, in some aspects, NB-IoT (e.g., associated with small data communications, such as short message service (SMS), or low data-rate voice) may not currently be compatible with existing NTN systems and/or deployments.

Various aspects relate generally to a custom-designed signal mapping approach to allow NB-IoT over existing large-granularity NTN TDD systems. Some aspects more specifically relate to initial access and/or cell acquisition design aspects for NB-IoT over existing large-granularity NTN TDD systems. In some examples, a wireless device may be configured to determine a TDD frame repetition unit for a NTN cell, where the TDD frame repetition unit specifies a TDD frame structure spanning multiple radio frames within a repetition period, monitor, based on the TDD frame repetition unit, at least one signal, of a set of signals, associated with cell acquisition for NB-IoT over the NTN cell, and communicate with the NTN cell based on the at least one monitored signal associated with the cell acquisition.

Particular aspects of the subject matter described in this disclosure can be implemented to realize one or more of the following potential advantages. In some examples, by deploying and/or implementing a custom-designed signal mapping for initial access and/or cell acquisition associated with NB-IoT, the described techniques can be used to allow NB-IoT over existing large-granularity NTN TDD systems.

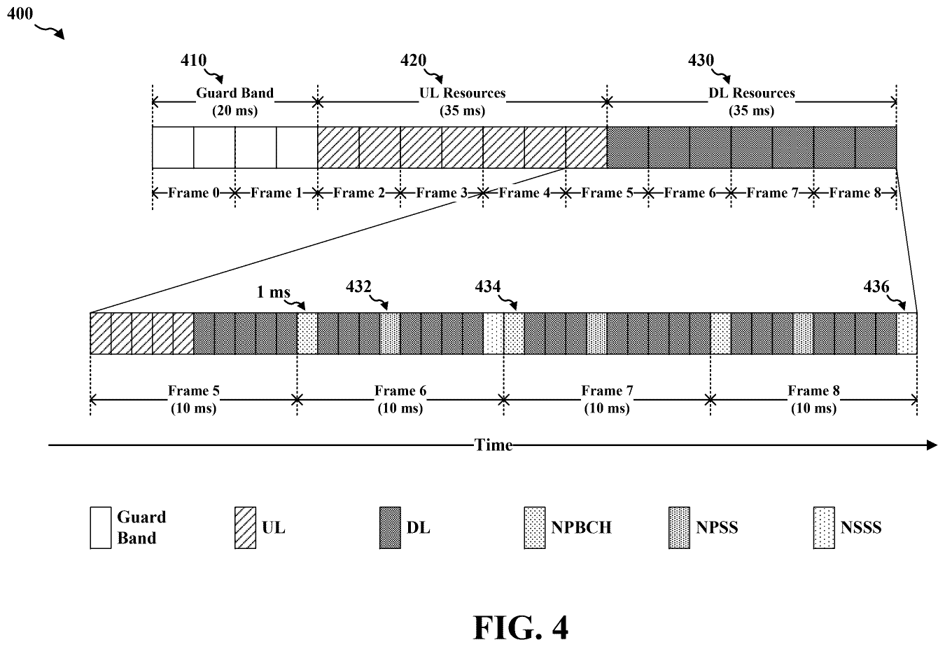

FIG. 4 is a diagram 400 illustrating a TDD frame repetition unit in accordance with some aspects of the disclosure. Diagram 400 illustrates an example of a large-granularity TDD frame repetition unit (e.g., a TDD frame structure spanning multiple radio frames within a repetition period which may be referred to below as a TDD multi-frame repeating unit, an NTN TDD frame repetition unit, or an NTN TDD multi-frame repeating unit) with a duration of 90 ms associated with a first NTN TDD system, where other durations and/or TDD patterns may be accommodated for other NTN TDD systems. A TDD frame repetition unit, in some aspects, may include a first time period and/or multi-frame repeating sub-unit associated with neither UL or DL (e.g., guard band 410). The TDD frame repetition unit, in some aspects, may further include a second time period and/or multi-frame repeating sub-unit associated with UL resources (e.g., UL resources 420), and a third time period and/or multi-frame repeating sub-unit associated with DL resources (e.g., DL resources 430).

In some aspects a set of initial access and/or cell acquisition signals may be mapped (e.g., in accordance with an NB-IoT pattern) to DL resources within the DL resources 430. For example, one or more of a narrowband primary synchronizations (NPSS) 432, a narrowband secondary synchronization signal (NSSS) 436, a narrowband physical broadcast channel (NPBCH) 434, or a SIB may be scheduled during the DL resources 430. The mapping illustrated in diagram 400, in some aspects, may represent the overlap between a current NB-IoT mapping and an aligned NTN TDD pattern (e.g., when the NB-IoT pattern and the NTN TDD frame repetition unit begin at a same time). However, as the NB-IoT pattern, in some aspects, may be associated with a first duration (or period) that is not equal to, a multiple of, or a factor of, a duration (or period) of the (NTN) TDD frame repetition unit, a naïve repetition of the NB-IoT pattern may lead to misalignment, or inconsistent alignment, of the signals of the NB-IoT pattern within the DL resources (e.g., DL resources 430) of the NTN TDD frame repetition unit. Accordingly, an NTN TDD pattern-specific NB-IoT pattern may be designed, specified, and/or configured. In some aspects, each such NTN TDD pattern-specific design, specification, and/or configuration may be associated with a specific frequency band (e.g., NB-IoT for NTN may use “band specificity” to allow for access to different NTN TDD systems). For example, to access a first NTN TDD system, an NB-IoT UE may use a first NB-IoT pattern and/or configuration (e.g., physical layer attributes) and an associated first frequency band, while to access a second NTN TDD system, an NB-IoT UE may use a second NB-IoT pattern and/or configuration (e.g., physical layer attributes) and an associated second frequency band.

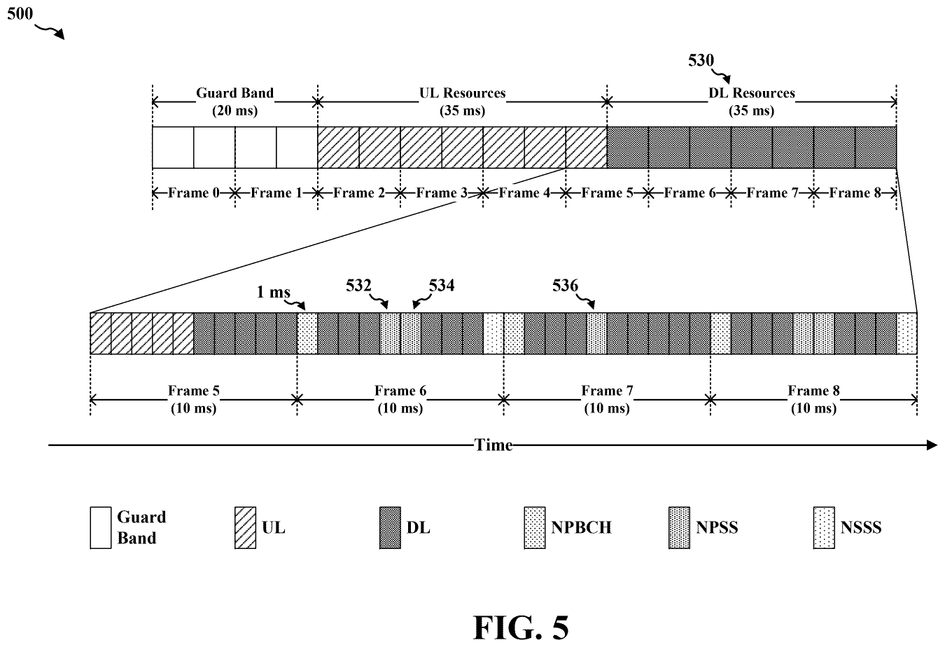

FIG. 5 is a diagram 500 illustrating an example NB-IoT pattern in accordance with some aspects of the disclosure. Diagram 500 illustrates that the NB-IoT pattern may be associated with a larger number of NPSS opportunities associated with the DL resources 530 of the NTN TDD frame repetition unit and/or pattern than the naïve mapping illustrated in diagram 400 of FIG. 4. For example, in the place of the single NPSS opportunity (e.g., a single slot including an NPSS) in each full DL frame in FIG. 4, diagram 500 illustrates that one or more DL frames (system frames that include DL slots but not UL slots such as frame 6 and frame 8 or a system frame that includes at least some DL slots) may include multiple NPSS opportunities and/or transmissions (e.g., NPSS 532 and NPSS 534) while others may include a single NPSS opportunities and/or transmissions (e.g., NPSS 536).

In some aspects, the frame structure illustrated in diagram 500 may include a set of SIBs that may be based on a customized SIB1-NB mapping. The customized SIB1-NB mapping, in some aspects, may be based on a non-uniform pattern. For example, 2 or 3 repetitions spaced 20 ms apart may be mapped within the DL resources 530 (e.g., during a 35 ms period associated with DL transmissions) and may be repeated every 90 ms (during each NTN TDD frame repetition unit). In some aspects, the periodicity associated with SIB1 repetitions may use a shorter period such as 10 ms. The customized SIB1-NB mapping for NTN, in some aspects, may be specified as an additional offset train to a current train. In some aspects, a MIB may include an indication of the customized SIB1-NB mapping and/or a frequency associated with the NTN system may be associated with the customized SIB1-NB mapping (along with other physical layer attributes). The customized SIB1-NB mapping, in some aspects, may be associated with a different pattern of SIBs configured to mask out legacy NB-IoT UEs. For other SIBs scheduled by SIB1 NB, characteristics such as SI-window length, SI-periodicity and SI-repetition pattern may determine scheduling and may not be compatible with the NTN TDD frame repetition unit structure. Accordingly, a new pattern and/or mapping for the other SIBs may be specified (e.g., based on specific values for SI-window length, SI-periodicity and SI-repetition pattern, and based on additional indications relating of flags, masking, or other characteristics) to make the transmission of the other SIBS compatible with the NTN TDD frame repetition unit structure.

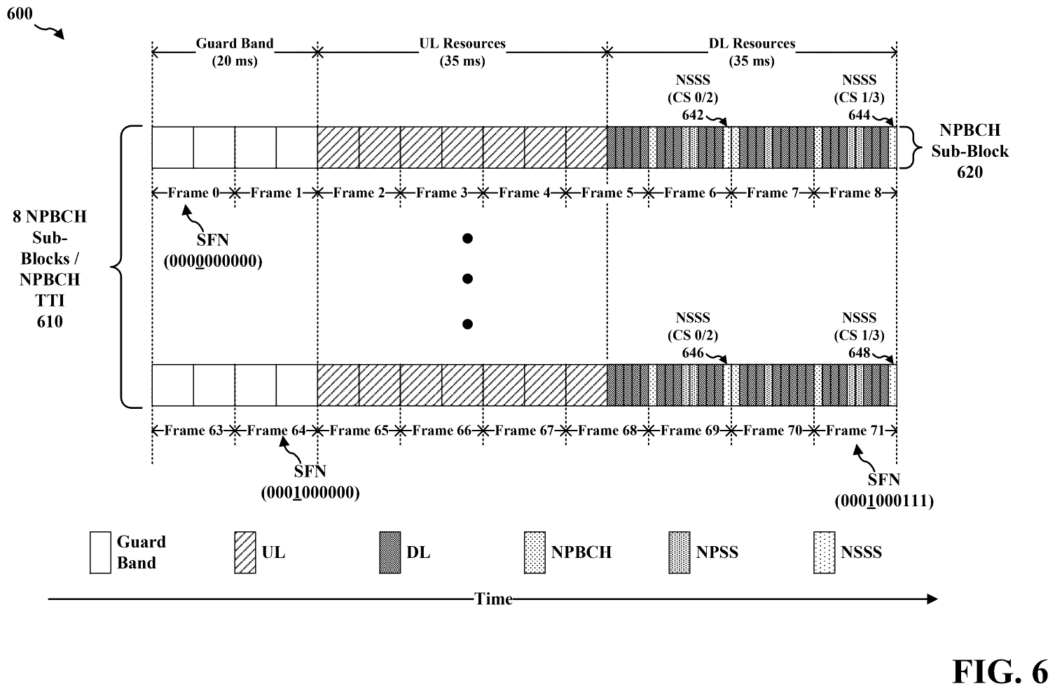

FIG. 6 is a diagram 600 illustrating a set of NPBCH sub-block repetitions in accordance with some aspects of the disclosure. Assuming an NTN TDD frame repetition unit and/or pattern of 90 ms as for FIGS. 4 and 5, an NPBCH sub-block 620 may be defined with a 90 ms period with NPBCH transmissions restricted to the last three frames (e.g., n_{f}mod9 ∈{6,7,8}) of the NTN TDD frame repetition unit and/or the NPBCH sub-block (e.g., NPBCH sub-block 620). The NPBCH sub-block may be repeated 8 times over a 720 ms PBCH transmission time interval (TTI) (e.g., an adjusted NPBCH TTI such as NPBCH TTI 610). As illustrated, for a first NPBCH sub-block beginning at a first frame of a system frame number (SFN) wraparound period, the first four bits (e.g., the four most significant bits (MSBs)) of the 10-bit SFN may be “0000” while for the last eight frames of the last NPBCH sub-block within the NPBCH TTI 610, the SFN may begin with “0001.” In some aspects of wireless communication using an NPBCH sub-block spanning 80 ms (e.g., repeating every 80 ms for a total NPBCH TTI of 640 ms), the NPBCH transmissions may be assumed to all share a same four MSBs such that NPBCH sub-block may be unambiguously identified by the four MSBs indicated in the NPBCH and a location of an NPBCH transmission within the NPBCH sub-block may be identified and/or determined based on a modulo operation on the SFN based on the number of frames in the NPBCH TTI (e.g., n_{f}mod64) and/or a cyclic shift associated with an NSSS. However, when using a NPBCH TTI of 720 ms (e.g., as an example of a TTI spanning a number of frames that cannot share a set of four MSBs of the SFN), the changing value of the fourth MSB may not allow for unambiguous identification of the NPBCH sub-block and the fourth MSB indicated in the NPBCH may be replaced with a fixed value that may be ignored in identifying the NPBCH sub-block (or may be a variable value used to indicate other information) where the NPBCH sub-block and/or a location of an NPBCH transmission within the NPBCH sub-block may be identified and/or determined based on a modulo operation on the SFN based on the number of frames in the NPBCH TTI (e.g., n_{f}mod72) and/or a cyclic shift associated with an NSSS. Accordingly, the NPBCH transmissions may be configured such that NPBCH indicates the three MSBs and the seven least significant bits (LSBs) (including the fourth MSB) may be identified based on one or more of hypothesis testing (e.g., based on a result of n_{f}mod72, where a value of 0-8 indicates a first NPBCH sub-block within the NPBCH TTI, and a value of 64-71 indicates a last NPBCH sub-block with the NPBCH TTI) and/or an NSSS cyclic shift (e.g., where the NSSS 642 and the NSSS 644 may use first candidate cyclic shift (0 or 1) while the NSSS 646 and the NSSS 648 may use a second candidate cyclic shift (2 or 3) to indicate whether it is a first or last repeated NPBCH sub-block within the NPBCH TTI).

In some aspects, the NPBCH start frame for NPBCH mapping may be based on a multiple of 72 (e.g., n_{f}mod72=0) and may further be based on an offset (e.g., Offset+(n_{f}mod72=0), where Offset is a term configured to constrain the NPBCH to frames satisfying n_{f}mod9 ∈{6,7,8}). The scrambling sequence, in some aspects, may re-initialized after 72 frames (e.g., after the NPBCH TTI 610). In some aspects, the use of the adjusted NPBCH TTI may allow for 24 NPBCH repetitions in every 720 ms TTI, as opposed to 21 or 22 repetitions when using an 80 ms NPBCH sub-block duration. Additionally, the NPBCH sub-blocks may share a same structure such that the same number of repetitions are associated with each NPBCH sub-block which may mitigate issues associated with rate-matching.

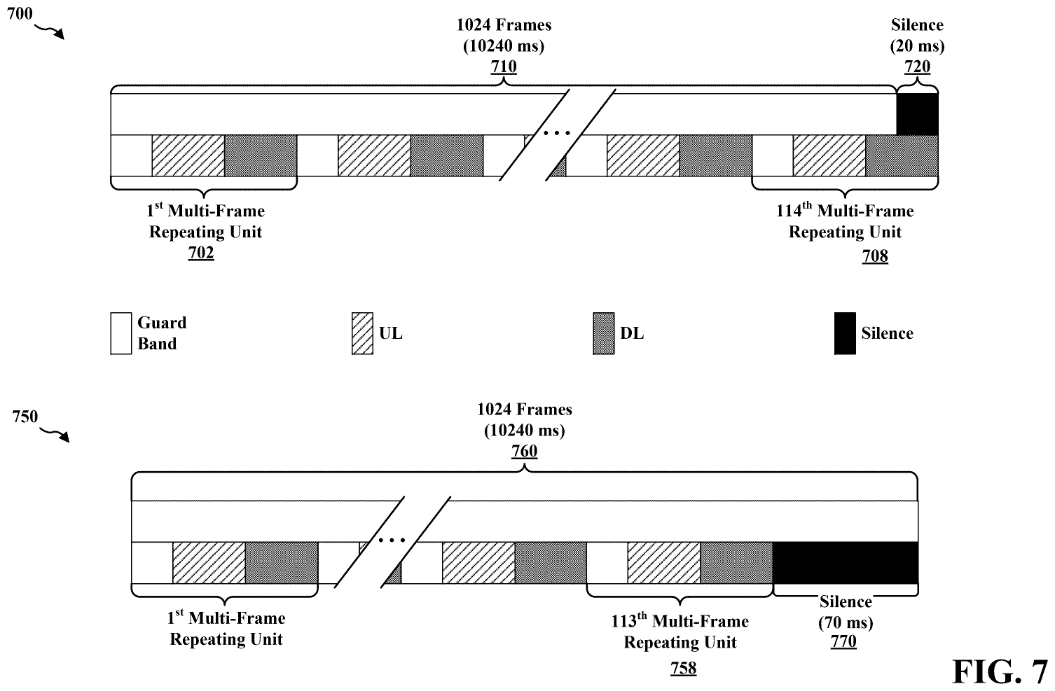

FIG. 7 is a set of diagrams (diagram 700 and diagram 750) illustrating a first and second configuration for frame numbering in accordance with some aspects of the disclosure. Diagram 700 illustrates that there may be a misalignment between a 90 ms NTN TDD repeating unit (e.g., the 114th multi-frame repeating unit 708) when a first multi-frame repeating unit 702 begins at the same time (e.g., slot and/or symbol) as a first frame of a set of 1024 frames 710 (e.g., a set of frames associated with a 10-bit SFN). As illustrated, the 114th multi-frame repeating unit 708 may extend beyond the last frame of the set of 1024 frames 710. In order to address the misalignment of the last NTN TDD repeating unit, in some aspects, the set of 1024 frames 710 may be followed by a period of silence 720 until the end of the 114th multi-frame repeating unit 708.

Diagram 750 illustrates an alternative configuration for addressing the misalignment. For example, instead of introducing a period of silence that may cause a misalignment between SFNs used for NTN NB-IoT and SFNs used for a terrestrial network, the period of silence 770 may be introduced after a 113th multi-frame repeating unit 758 such that a set of 113 NTN TDD repeating units are transmitted within the set of 1024 frames 760. While using the configuration illustrated in diagram 750 may address the misalignment of the SFNs used for NTN NB-IoT and SFNs used for the terrestrial network, the overhead associated with the period of silence 770 (e.g., 70 ms as shown or, in some aspects, 160 ms if the number of NTN TDD repeating units should be a multiple of eight to not interrupt a set of NPBCH sub-blocks associated with an NPBCH TTI) may be greater than the overhead associated with the period of silence 720 illustrated in diagram 700.

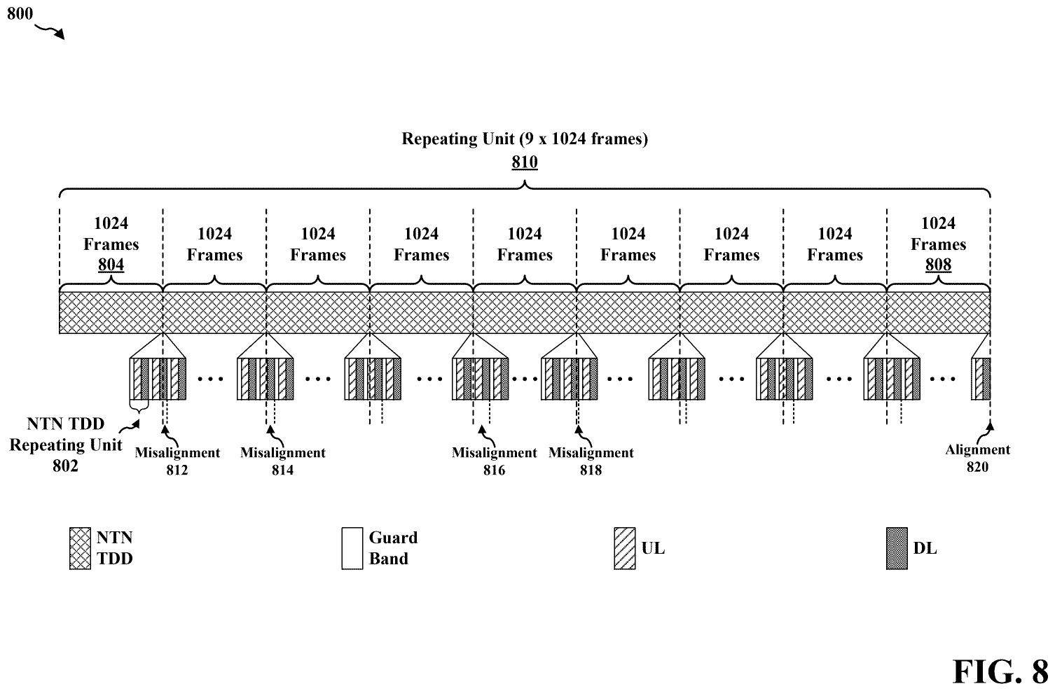

FIG. 8 is a diagram 800 illustrating a configuration for frame numbering in accordance with some aspects of the disclosure. As illustrated in diagram 800, a plurality of sets of 1024 frames may make up a repeating unit 810 for an additional index (e.g., an index indicating a set of 1024 frames in a plurality of sets of 1024 frames). As described in relation to FIG. 7, for an NTN TDD repeating unit 802 with a duration of 90 ms, an NTN TDD repeating unit may experience misalignment 812 (e.g., 20 ms between the end of the first set of 1024 frames 804 and the end of the current NTN TDD repeating unit) with the end of a first set of 1024 frames. Similarly, at the end of additional sets of 1024 frames, the NTN TDD repeating units may experience misalignment 814 (e.g., 40 ms), misalignment 816 (e.g., 80 ms), or misalignment 818 (e.g., 10 ms). At the end of repeating unit 810, the NTN TDD repeating unit and a ninth set of 1024 frames 808 may end in alignment 820. While illustrated in respect to an NTN TDD repeating unit duration of 90 ms, the method may be applied to NTN TDD repeating units with different durations. For example, for an NTN TDD repeating unit duration of 70 ms, the repeating unit may include seven sets of 1024 frames, or for an NTN TDD repeating unit duration of 60 ms, the repeating unit may include three sets of 1024 frames. The possible values of the additional index, in some aspects, may be based on the number of sets of 1024 frames included in the plurality of sets of 1024 frames making up the repeating unit (e.g., the repeating unit 810).

Using the configuration illustrated in FIG. 8 as an example, a location within the repeating unit 810 may be signaled in addition to an SFN within a set of 1024 frames (e.g., within the first set of 1024 frames 804 or the ninth set of 1024 frames 808). In some aspects, the signaling may be via an MIB (e.g., the MIB may indicate a value between 0 and 8 using a set of 4 bits in a set of spare bits). The location may be signaled, in some aspects, via an N_{Cell} ID. For example, the N_{cell} ID s for each set of 1024 frames within the repeating unit 810 may be limited to values such that N_{Cell} ID mod 9 is equal to the value associated with the set of 1024 frames. In some aspects, the location may be signaled by a combination of the N_{cell} ID and a CS associated with an NSSS transmitted within the set of 1024 frames. For example, a unique value may be associated with, or identified by, a combination of N_{cell} ID mod 5 and a particular CS (from a set of two CSs) associated with the NSSS.

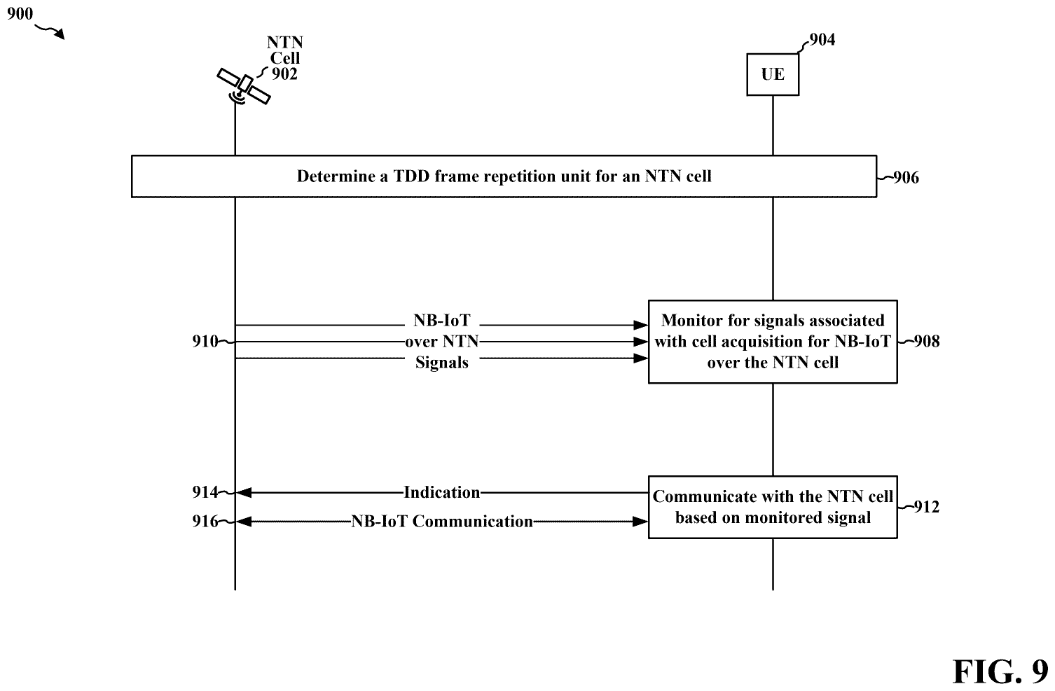

FIG. 9 is a call flow diagram 900 illustrating a method of wireless communication for NB-IoT over NTN in accordance with some aspects of the disclosure. The method is illustrated in relation to an NTN cell 902 (e.g., as an example of a network device or network node that may include one or more components of a disaggregated base station) in communication with a UE 904 (e.g., as an example of a wireless device). The functions ascribed to the NTN cell 902, in some aspects, may be performed by one or more components of a network entity, a network node, or a network device (a single network entity/node/device or a disaggregated network entity/node/device as described above in relation to FIG. 1). Similarly, the functions ascribed to the UE 904, in some aspects, may be performed by one or more components of a wireless device supporting communication with a network entity/node/device. Accordingly, references to “transmitting” in the description below may be understood to refer to a first component of the NTN cell 902 (or the UE 904) outputting (or providing) an indication of the content of the transmission to be transmitted by a different component of the NTN cell 902 (or the UE 904). Similarly, references to “receiving” in the description below may be understood to refer to a first component of the NTN cell 902 (or the UE 904) receiving a transmitted signal and outputting (or providing) the received signal (or information based on the received signal) to a different component of the NTN cell 902 (or the UE 904).

In some aspects, at 906, the NTN cell 902 and the UE 904 may determine a TDD frame repetition unit for the NTN cell 902. In some aspects, determining the TDD frame repetition unit at 906, may include determining a TDD frame structure spanning multiple radio frames within a repetition period. One or more physical layer attributes for a set of signals associated with cell acquisition for NB-IoT over the NTN cell 902 may be associated with the TDD frame structure. The set of signals, in some aspects, may include one or more of a set of NPSS, a set of NSSS, a NPBCH, or a SIB. The TDD frame repetition unit may be associated with a frequency band associated with the NTN cell 902. The TDD frame repetition unit, in some aspects, may be repeated with a first periodicity and may include a first repeating sub-unit spanning multiple radio frames associated with UL resources (e.g., UL resources 420) and a second repeating sub-unit spanning multiple radio frames associated with DL resources (e.g., DL resources 430 and 530). In some aspects, one or more physical layer attributes for the set of signals may include a first mapping to resources associated with the second repeating sub-unit.

As illustrated in relation to FIGS. 5 and 6, in some aspects, the TDD frame repetition unit may include multiple NPSS transmissions and a time period between a first NPSS in the set of NPSSs and an adjacent NPSS in the set of NPSSs within the second repeating sub-unit is shorter than one frame. In some aspects, each NSSS among the one or more NSSSs is associated with a corresponding cyclic shift in a set of cyclic shifts, where the corresponding cyclic shift indicates a position in time within the second repeating sub-unit. The set of cyclic shifts, in some aspects, may include four cyclic shifts, and at least one position of an NSSS in time within the second repeating sub-unit is associated with a plurality of cyclic shifts from among the set of cyclic shifts, and the plurality of cyclic shifts may be used to indicate other information. The TDD frame repetition unit, in some aspects, may include a set of SIBs specific to the NTN cell transmitted within each second repeating sub-unit multiple SIBs, where the location of the SIBs within the TDD frame repetition unit may be based on a customized SIB1-NB mapping as described in relation to FIG. 6. In some aspects, the set of SIBs includes a first type of NB SIB (e.g., a SIB1) scheduled based on a known configuration and/or mapping and one or more additional NB SIBs scheduled based on parameters indicated in the first type of NB SIB. The parameters, in some aspects may include one or more of a window length, a periodicity, and a repetition pattern specific to the NTN cell (e.g., from a set of known or preconfigured repetition patterns).

In some aspects, an NPBCH sub-block of an NPBCH may be transmitted in the second repeating sub-unit. A TTI associated with the NPBCH, in some aspects, may be associated with the TDD frame repetition unit. A second periodicity associated with the NPBCH sub-block of the NPBCH may be equal to the first periodicity, and the NPBCH sub-block may be repeated a plurality of times over a plurality of TDD frame repetition units spanning the TTI. In some aspects, a starting frame for mapping the NPBCH to a resource and/or a scrambling sequence re-initialization associated with the NPBCH may be based on at least one of a number of radio frames associated with at least one of the plurality of TDD frame repetition units and/or the first periodicity, or may be based on a location of the starting frame within the second repeating sub-unit a starting frame.

An SFN indicated in the NPBCH signaling, in some aspects, may indicate the SFN via a set of three MSBs of a 10-bit SFN that are common to frames transmitted within the TTI, and a fixed value may be used to indicate at least a fourth MSB of the 10-bit SFN that is not common to the frames transmitted within the TTI. In some aspects, the seven LSBs may be determined based on one or more of hypothesis testing or an NSSS cyclic shift as discussed in relation to FIG. 6. In some aspects, the SFN associated with the NTN cell resets at a first time that exceeds a maximum time duration associated with a 10-bit SFN by a first duration (e.g., the 20 ms silence illustrated in diagram 700 of FIG. 7), where the first duration is a period without scheduled communications from the NTN cell, and where the first duration is less than the first periodicity. An additional index, in some aspects, may be signaled to identify a set of 1024 frames numbered based on a 10-bit SFN within a plurality of consecutive sets of 1024 frames numbered based on the 10-bit SFN (e.g., as described in relation to FIG. 8). In some aspects, the additional index of the set of frames within the plurality of consecutive sets of frames is indicated via one of a first set of bits in an MIB, a second set of bits in a cell identifier field (e.g., an N_{cell} ID) associated with an NSSS, or a combination of a third set of bits in the cell identifier field associated with the NSSS and a cyclic shift value associated with the NSSS. The plurality of consecutive sets of 1024 frames numbered based on the 10-bit SFN, in some aspects, may include a number of sets of 1024 frames based on a least common multiple of a duration associated with the set of frames (e.g., the first set of 1024 frames 804 or the ninth set of 1024 frames 808 as illustrated in FIG. 8) and the first periodicity (e.g., the 90 ms periodicity of the TDD frame repetition unit).

Based on determining the frame repetition unit for the NTN cell 902 at 906, the UE 904 may, at 908, monitor for at least one signal, of a set of signals, associated with cell acquisition for NB-IoT over the NTN cell. The monitored at least one signal may be a signal in one (or more) of the set of NPSS, the set of NSSS, the NPBCH, or the SIB. While the UE 904 monitors for the at least one signal at 908, the NTN cell 902 may transmit a set of NB-IoT over NTN cell acquisition signals 910. The UE 904, based on the at least one monitored signal (e.g., at least one of the NTN cell acquisition signals 910) may camp on (or acquire) the NTN cell 902.

Based on acquiring the NTN cell 902, the UE 904 may, at 912, communicate with the NTN cell based on the at least one monitored signal associated with the cell acquisition. In some aspects, the communication at 912 may include a transmission of an indication 914 based on the at least one monitored signal. Additionally, or alternatively, as part of the communication at 912, the NTN cell 902 and the UE 904 may exchange NB-IoT communication 916.

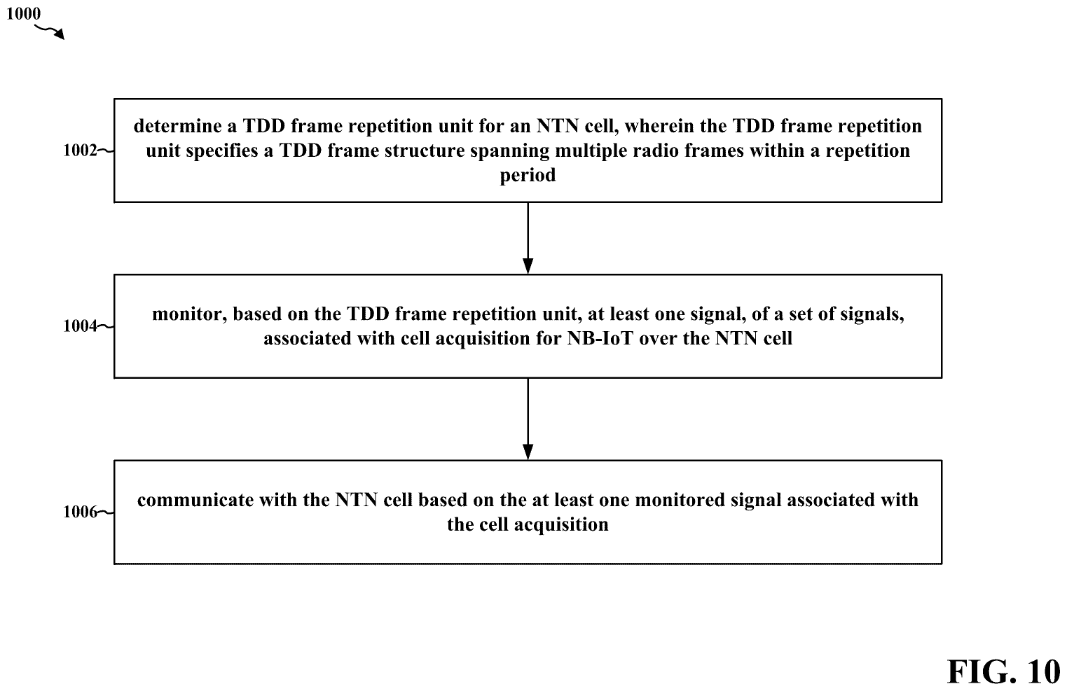

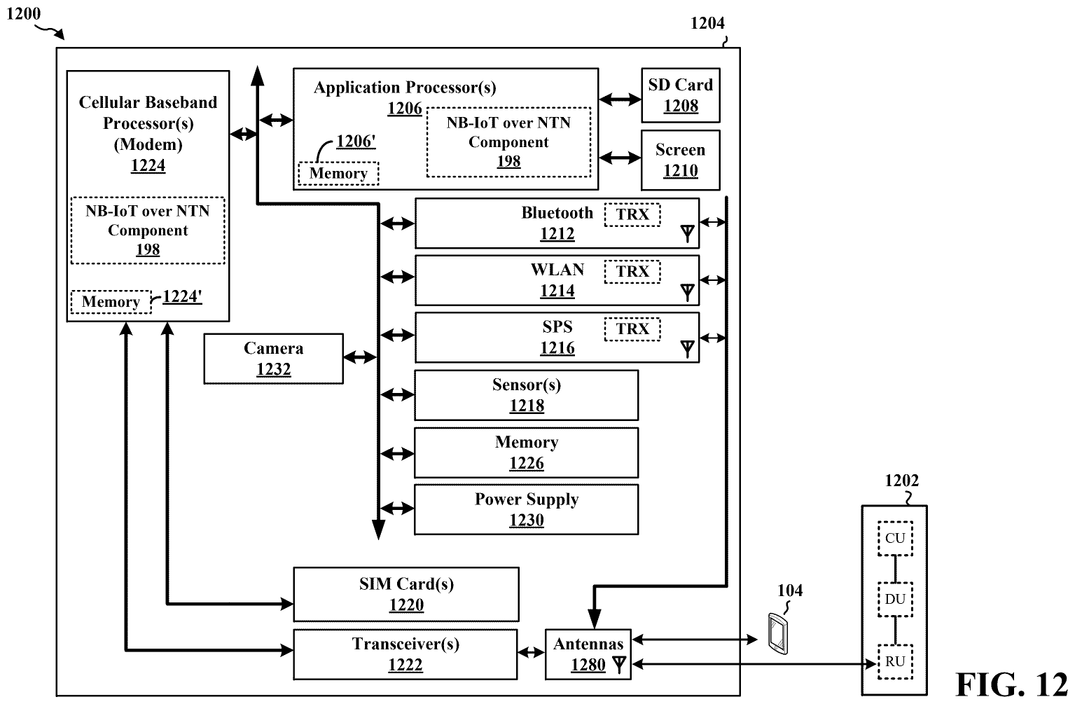

FIG. 10 is a flowchart 1000 of a method of wireless communication. The method may be performed by a UE (e.g., the UE 104, 904; the apparatus 1204). At 1002, the UE may determine a TDD frame repetition unit for an NTN cell. For example, 1002 may be performed by application processor(s) 1206, cellular baseband processor(s) 1224, transceiver(s) 1222, antenna(s) 1280, and/or NB-IoT over NTN component 198 of FIG. 12. In some aspects, the TDD frame repetition unit specifies a TDD frame structure spanning multiple radio frames within a repetition period. For example, referring to FIG. 9, the UE 904 may, at 906, determine a TDD frame repetition unit for the NTN cell 902.

In some aspects, one or more physical layer attributes for a set of signals associated with cell acquisition for NB-IoT over the NTN cell may be associated with the TDD frame structure. The set of signals, in some aspects, may include one or more of a set of NPSS, a set of NSSS, a NPBCH, or a SIB. The TDD frame repetition unit may be associated with a frequency band associated with the NTN cell. The TDD frame repetition unit, in some aspects, may be repeated with a first periodicity and may include a first repeating sub-unit spanning multiple radio frames associated with UL resources (e.g., UL resources 420) and a second repeating sub-unit spanning multiple radio frames associated with DL resources (e.g., DL resources 430 and 530). In some aspects, one or more physical layer attributes for the set of signals may include a first mapping to resources associated with the second repeating sub-unit.

The TDD frame repetition unit, in some aspects, may include multiple NPSS transmissions and a time period between a first NPSS in the set of NPSSs and an adjacent NPSS in the set of NPSSs within the second repeating sub-unit is shorter than one frame. In some aspects, each NSSS among the one or more NSSSs is associated with a corresponding cyclic shift in a set of cyclic shifts, where the corresponding cyclic shift indicates a position in time within the second repeating sub-unit. The set of cyclic shifts, in some aspects, may include four cyclic shifts, and at least one position of an NSSS in time within the second repeating sub-unit is associated with a plurality of cyclic shifts from among the set of cyclic shifts, and the plurality of cyclic shifts may be used to indicate other information. The TDD frame repetition unit, in some aspects, may include a set of SIBs specific to the NTN cell transmitted within each second repeating sub-unit multiple SIBs, where the location of the SIBs within the TDD frame repetition unit may be based on a customized SIB1-NB mapping as described in relation to FIG. 6. In some aspects, the set of SIBs includes a first type of SIB (e.g., a SIB1 associated with cell acquisition for NB-IoT) scheduled based on a known configuration and/or mapping and one or more additional SIBs (e.g., additional types of SIBs associated with cell acquisition for NB-IoT) scheduled based on parameters indicated in the first type of SIB. The parameters, in some aspects may include one or more of a window length, a periodicity, and a repetition pattern specific to the NTN cell (e.g., from a set of known or preconfigured repetition patterns).

In some aspects, an NPBCH sub-block of an NPBCH may be transmitted in the second repeating sub-unit. A TTI associated with the NPBCH, in some aspects, may be associated with the TDD frame repetition unit. A second periodicity associated with the NPBCH sub-block of the NPBCH may be equal to the first periodicity, and the NPBCH sub-block may be repeated a plurality of times over a plurality of TDD frame repetition units spanning the TTI. In some aspects, a starting frame for mapping the NPBCH to a resource and/or a scrambling sequence re-initialization associated with the NPBCH may be based on at least one of a number of radio frames associated with at least one of the plurality of TDD frame repetition units and/or the first periodicity, or may be based on a location of the starting frame within the second repeating sub-unit a starting frame.

An SFN indicated in the NPBCH signaling, in some aspects, may indicate the SFN via a set of three MSBs of a 10-bit SFN that are common to frames transmitted within the TTI, and a fixed value may be used to indicate at least a fourth MSB of the 10-bit SFN that is not common to the frames transmitted within the TTI. In some aspects, the seven LSBs may be determined based on one or more of hypothesis testing or an NSSS cyclic shift as discussed in relation to FIG. 6. In some aspects, the SFN associated with the NTN cell resets at a first time that exceeds a maximum time duration associated with a 10-bit SFN by a first duration (e.g., the 20 ms silence illustrated in diagram 700 of FIG. 7), where the first duration is a period without scheduled communications from the NTN cell, and where the first duration is less than the first periodicity. An additional index, in some aspects, may be signaled to identify a set of 1024 frames numbered based on a 10-bit SFN within a plurality of consecutive sets of 1024 frames numbered based on the 10-bit SFN (e.g., as described in relation to FIG. 8). In some aspects, the additional index of the set of frames within the plurality of consecutive sets of frames is indicated via one of a first set of bits in an MIB, a second set of bits in a cell identifier field (e.g., an N_{cell} ID) associated with an NSSS, or a combination of a third set of bits in the cell identifier field associated with the NSSS and a cyclic shift value associated with the NSSS. The plurality of consecutive sets of 1024 frames numbered based on the 10-bit SFN, in some aspects, may include a number of sets of 1024 frames based on a least common multiple of a duration associated with the set of frames (e.g., the first set of 1024 frames 804 or the ninth set of 1024 frames 808 as illustrated in FIG. 8) and the first periodicity (e.g., the 90 ms periodicity of the TDD frame repetition unit).

At 1004, the UE may monitor, based on the TDD frame repetition unit, at least one signal, of a set of signals, associated with cell acquisition for NB-IoT over the NTN cell. For example, 1004 may be performed by application processor(s) 1206, cellular baseband processor(s) 1224, transceiver(s) 1222, antenna(s) 1280, and/or NB-IoT over NTN component 198 of FIG. 12. In some aspects, the monitored at least one signal may be a signal in one (or more) of the set of NPSS, the set of NSSS, the NPBCH, or the SIB. the TDD frame repetition unit specifies a TDD frame structure spanning multiple radio frames within a repetition period. For example, referring to FIG. 9, the UE 904 may, at 908, monitor for at least one signal, of a set of signals, associated with cell acquisition for NB-IoT over the NTN cell.

At 1006, the UE may communicate with the NTN cell based on the at least one monitored signal associated with the cell acquisition. In some aspects, communicating with the NTN TDD cell based on the at least one monitored signal at 1006 may include transmitting an indication based on the at least one monitored signal. For example, 1006 may be performed by application processor(s) 1206, cellular baseband processor(s) 1224, transceiver(s) 1222, antenna(s) 1280, and/or NB-IoT over NTN component 198 of FIG. 12. For example, referring to FIG. 9, the UE 904 may, at 912, communicate with the NTN cell based on the at least one monitored signal associated with the cell acquisition.

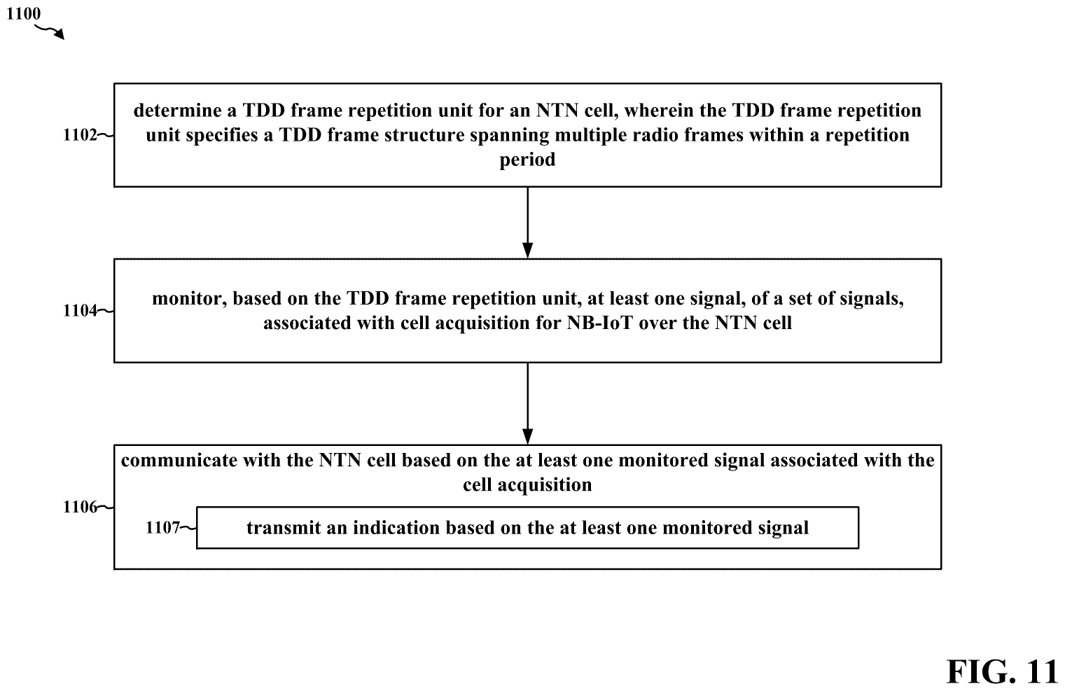

FIG. 11 is a flowchart 1100 of a method of wireless communication. The method may be performed by a UE (e.g., the UE 104, 904; the apparatus 1204). At 1102, the UE may determine a TDD frame repetition unit for an NTN cell. For example, 1102 may be performed by application processor(s) 1206, cellular baseband processor(s) 1224, transceiver(s) 1222, antenna(s) 1280, and/or NB-IoT over NTN component 198 of FIG. 12. In some aspects, the TDD frame repetition unit specifies a TDD frame structure spanning multiple radio frames within a repetition period. For example, referring to FIG. 9, the UE 904 may, at 906, determine a TDD frame repetition unit for the NTN cell 902.

In some aspects, one or more physical layer attributes for a set of signals associated with cell acquisition for NB-IoT over the NTN cell may be associated with the TDD frame structure. The set of signals, in some aspects, may include one or more of a set of NPSS, a set of NSSS, a NPBCH, or a SIB. The TDD frame repetition unit may be associated with a frequency band associated with the NTN cell. The TDD frame repetition unit, in some aspects, may be repeated with a first periodicity and may include a first repeating sub-unit spanning multiple radio frames associated with UL resources (e.g., UL resources 420) and a second repeating sub-unit spanning multiple radio frames associated with DL resources (e.g., DL resources 430 and 530). In some aspects, one or more physical layer attributes for the set of signals may include a first mapping to resources associated with the second repeating sub-unit.

The TDD frame repetition unit, in some aspects, may include multiple NPSS transmissions and a time period between a first NPSS in the set of NPSSs and an adjacent NPSS in the set of NPSSs within the second repeating sub-unit is shorter than one frame. In some aspects, each NSSS among the one or more NSSSs is associated with a corresponding cyclic shift in a set of cyclic shifts, where the corresponding cyclic shift indicates a position in time within the second repeating sub-unit. The set of cyclic shifts, in some aspects, may include four cyclic shifts, and at least one position of an NSSS in time within the second repeating sub-unit is associated with a plurality of cyclic shifts from among the set of cyclic shifts, and the plurality of cyclic shifts may be used to indicate other information. The TDD frame repetition unit, in some aspects, may include a set of SIBs specific to the NTN cell transmitted within each second repeating sub-unit multiple SIBs, where the location of the SIBs within the TDD frame repetition unit may be based on a customized SIB1-NB mapping as described in relation to FIG. 6. In some aspects, the set of SIBs includes a first type of NB SIB (e.g., a SIB1) scheduled based on a known configuration and/or mapping and one or more additional NB SIBs scheduled based on parameters indicated in the first type of NB SIB. The parameters, in some aspects may include one or more of a window length, a periodicity, and a repetition pattern specific to the NTN cell (e.g., from a set of known or preconfigured repetition patterns).

In some aspects, an NPBCH sub-block of an NPBCH may be transmitted in the second repeating sub-unit. A TTI associated with the NPBCH, in some aspects, may be associated with the TDD frame repetition unit. A second periodicity associated with the NPBCH sub-block of the NPBCH may be equal to the first periodicity, and the NPBCH sub-block may be repeated a plurality of times over a plurality of TDD frame repetition units spanning the TTI. In some aspects, a starting frame for mapping the NPBCH to a resource and/or a scrambling sequence re-initialization associated with the NPBCH may be based on at least one of a number of radio frames associated with at least one of the plurality of TDD frame repetition units and/or the first periodicity, or may be based on a location of the starting frame within the second repeating sub-unit a starting frame.

An SFN indicated in the NPBCH signaling, in some aspects, may indicate the SFN via a set of three MSBs of a 10-bit SFN that are common to frames transmitted within the TTI, and a fixed value may be used to indicate at least a fourth MSB of the 10-bit SFN that is not common to the frames transmitted within the TTI. In some aspects, the seven LSBs may be determined based on one or more of hypothesis testing or an NSSS cyclic shift as discussed in relation to FIG. 6. In some aspects, the SFN associated with the NTN cell resets at a first time that exceeds a maximum time duration associated with a 10-bit SFN by a first duration (e.g., the 20 ms silence illustrated in diagram 700 of FIG. 7), where the first duration is a period without scheduled communications from the NTN cell, and where the first duration is less than the first periodicity. An additional index, in some aspects, may be signaled to identify a set of 1024 frames numbered based on a 10-bit SFN within a plurality of consecutive sets of 1024 frames numbered based on the 10-bit SFN (e.g., as described in relation to FIG. 8). In some aspects, the additional index of the set of frames within the plurality of consecutive sets of frames is indicated via one of a first set of bits in an MIB, a second set of bits in a cell identifier field (e.g., an N_{cell} ID) associated with an NSSS, or a combination of a third set of bits in the cell identifier field associated with the NSSS and a cyclic shift value associated with the NSSS. The plurality of consecutive sets of 1024 frames numbered based on the 10-bit SFN, in some aspects, may include a number of sets of 1024 frames based on a least common multiple of a duration associated with the set of frames (e.g., the first set of 1024 frames 804 or the ninth set of 1024 frames 808 as illustrated in FIG. 8) and the first periodicity (e.g., the 90 ms periodicity of the TDD frame repetition unit).

At 1104, the UE may monitor, based on the TDD frame repetition unit, at least one signal, of a set of signals, associated with cell acquisition for NB-IoT over the NTN cell. For example, 1104 may be performed by application processor(s) 1206, cellular baseband processor(s) 1224, transceiver(s) 1222, antenna(s) 1280, and/or NB-IoT over NTN component 198 of FIG. 12. In some aspects, the monitored at least one signal may be a signal in one (or more) of the set of NPSS, the set of NSSS, the NPBCH, or the SIB. the TDD frame repetition unit specifies a TDD frame structure spanning multiple radio frames within a repetition period. For example, referring to FIG. 9, the UE 904 may, at 908, monitor for at least one signal, of a set of signals, associated with cell acquisition for NB-IoT over the NTN cell.

At 1106, the UE may communicate with the NTN cell based on the at least one monitored signal associated with the cell acquisition. In some aspects, communicating with the NTN TDD cell based on the at least one monitored signal at 1106 may include transmitting, at 1107, an indication based on the at least one monitored signal. For example, 1106 and 1107 may be performed by application processor(s) 1206, cellular baseband processor(s) 1224, transceiver(s) 1222, antenna(s) 1280, and/or NB-IoT over NTN component 198 of FIG. 12. For example, referring to FIG. 9, the UE 904 may, at 912, communicate with the NTN cell based on the at least one monitored signal associated with the cell acquisition.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize one or more antennas 1280 for communication. The cellular baseband processor(s) 1224 communicates through the transceiver(s) 1222 via the one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the NB-IoT over NTN component 198 may be configured to determine a TDD frame repetition unit for a NTN cell, where the TDD frame repetition unit specifies a TDD frame structure spanning multiple radio frames within a repetition period, monitor, based on the TDD frame repetition unit, at least one signal, of a set of signals, associated with cell acquisition for NB-IoT over the NTN cell, and communicate with the NTN cell based on the at least one monitored signal associated with the cell acquisition. The NB-IoT over NTN component 198 may be within the cellular baseband processor(s) 1224, the application processor(s) 1206, or both the cellular baseband processor(s) 1224 and the application processor(s) 1206. The NB-IoT over NTN component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for determining a time division duplex (TDD) frame repetition unit for a non-terrestrial network (NTN) cell. The apparatus 1204, and in particular the cellular baseband processor(s) 1224 and/or the application processor(s) 1206, may include means for monitoring, based on the TDD frame repetition unit, at least one signal, of a set of signals, associated with cell acquisition for Narrowband-Internet of Things (NB-IoT) over the NTN cell. The apparatus 1204, and in particular the cellular baseband processor(s) 1224 and/or the application processor(s) 1206, may include means for communicating with the NTN cell based on the at least one monitored signal associated with the cell acquisition. The apparatus 1204, and in particular the cellular baseband processor(s) 1224 and/or the application processor(s) 1206, may include means for transmitting an indication based on the at least one monitored signal. The apparatus 1204 may further include means for performing any of the aspects described in connection with the flowcharts in FIG. 10 or 11, and/or performed by the UE in the communication flow of FIG. 9. The means may be the NB-IoT over NTN component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

Various aspects relate generally to a custom-designed signal mapping approach to allow NB-IoT over existing large-granularity NTN TDD systems. Some aspects more specifically relate to initial access and/or cell acquisition design aspects for NB-IoT over existing large-granularity NTN TDD systems. In some examples, a wireless device may be configured to determine a TDD frame repetition unit for a NTN cell, where the TDD frame repetition unit specifies a TDD frame structure spanning multiple radio frames within a repetition period, monitor, based on the TDD frame repetition unit, at least one signal, of a set of signals, associated with cell acquisition for NB-IoT over the NTN cell, and communicate with the NTN cell based on the at least one monitored signal associated with the cell acquisition.

Particular aspects of the subject matter described in this disclosure can be implemented to realize one or more of the following potential advantages. In some examples, by deploying and/or implementing a custom-designed signal mapping for initial access and/or cell acquisition associated with NB-IoT, the described techniques can be used to allow NB-IoT over existing large-granularity NTN TDD systems.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE) comprising: determining a time division duplex (TDD) frame repetition unit for a non-terrestrial network (NTN) cell, wherein the TDD frame repetition unit specifies a TDD frame structure spanning multiple radio frames within a repetition period; monitoring, based on the TDD frame repetition unit, at least one signal, of a set of signals, associated with cell acquisition for Narrowband-Internet of Things (NB-IoT) over the NTN cell; and communicating with the NTN cell based on the at least one monitored signal associated with the cell acquisition.

Aspect 2 is the method of aspect 1, wherein the set of signals associated with the cell acquisition comprises one or more of a set of narrowband primary synchronization signals (NPSSs), a set of narrowband secondary synchronization signals (NSSSs), a narrowband physical broadcast channel (NPBCH), or a system information block (SIB).

Aspect 3 is the method of aspect 2, wherein the TDD frame repetition unit is repeated with a first periodicity and comprises a first repeating sub-unit spanning multiple radio frames associated with uplink (UL) resources and a second repeating sub-unit spanning multiple radio frames associated with downlink (DL) resources, wherein one or more physical layer attributes of the set of signals is associated with the TDD frame repetition unit, and wherein the one or more physical layer attributes comprise a first mapping to resources associated with the second repeating sub-unit.

Aspect 4 is the method of aspect 3, wherein a time period between a first NPSS in the set of NPSSs and an adjacent NPSS in the set of NPSSs within the second repeating sub-unit is shorter than one frame.

Aspect 5 is the method of any of aspects 3 and 4, wherein the set of NSSSs comprises one or more NSSSs that are transmitted within each second repeating sub-unit.

Aspect 6 is the method of aspect 5, wherein each NSSS among the one or more NSSSs is associated with a corresponding cyclic shift in a set of cyclic shifts, wherein the corresponding cyclic shift indicates a position in time within the second repeating sub-unit.

Aspect 7 is the method of aspect 6, wherein the set of cyclic shifts comprises four cyclic shifts, wherein at least one position in time of an NSSS within the second repeating sub-unit is associated with a plurality of cyclic shifts from among the set of cyclic shifts, and wherein the plurality of cyclic shifts is used to indicate other information.

Aspect 8 is the method of any of aspects 3 to 7, wherein an NPBCH sub-block of an NPBCH is transmitted in the second repeating sub-unit.

Aspect 9 is the method of aspect 8, wherein a transmission time interval (TTI) associated with the NPBCH is associated with the TDD frame repetition unit, wherein a second periodicity associated with an NBPCH sub-block of the NPBCH is equal to the first periodicity, and wherein the NPBCH sub-block is repeated a plurality of times over a plurality of TDD frame repetition units spanning the TTI.

Aspect 10 is the method of aspect 9, wherein a starting frame for mapping the NPBCH to a resource is based on at least one of: a number of radio frames associated with at least one of the plurality of TDD frame repetition units, or the first periodicity; or a location of the starting frame within the second repeating sub-unit.

Aspect 11 is the method of any of aspects 9 and 10, wherein a system frame number (SFN) indicated in the NPBCH signaling indicates the SFN via a set of three most significant bits (MSBs) of a 10-bit SFN that are common to frames transmitted within the TTI, and wherein a fixed value is used to indicate at least a fourth MSB of the 10-bit SFN that is not common to the frames transmitted within the TTI.

Aspect 12 is the method of any of aspects 9 to 11, wherein a system frame number (SFN) associated with the NTN cell resets at a first time that exceeds a maximum time duration associated with a 10-bit SFN by a first duration, wherein the first duration is a period without scheduled communications from the NTN cell, and wherein the first duration is less than the first periodicity.

Aspect 13 is the method of any of aspects 9 to 12, wherein an additional index is signaled to identify a set of frames numbered based on a 10-bit system frame number (SFN) within a plurality of consecutive sets of frames numbered based on the 10-bit SFN.

Aspect 14 is the method of aspect 13, wherein the additional index of the set of frames within the plurality of consecutive sets of frames is indicated via one of: a first set of bits in a master information block; a second set of bits in a cell identifier field associated with a NSSS; or a combination of a third set of bits in the cell identifier field associated with the NSSS and a cyclic shift value associated with the NSSS.

Aspect 15 is the method of any of aspects 3 to 14, wherein a set of SIBs specific to the NTN cell is transmitted within each second repeating sub-unit.

Aspect 16 is the method of aspect 15, wherein the set of SIBs comprises: a first type of SIB scheduled based on a known configuration; and one or more additional SIBs scheduled based on parameters indicated in the first type of SIB, wherein the parameters comprise one or more of a window length, a periodicity, and a repetition pattern specific to the NTN cell.

Aspect 17 is the method of aspect 9, wherein a starting frame for mapping the NPBCH to a resource is based on at least one of: a number of radio frames associated with at least one of the plurality of TDD frame repetition units, or the first periodicity; or a location of the starting frame within the second repeating sub-unit.

Aspect 18 is the method of any of aspects 1 to 17, wherein communicating with the NTN cell based on the at least one monitored signal comprises transmitting an indication based on the at least one monitored signal.

Aspect 19 is an apparatus for wireless communication at a device including a memory and at least one processor coupled to the memory and, based at least in part on information stored in the memory, the at least one processor is configured to implement any of aspects 1 to 18.

Aspect 20 is the apparatus of aspect 19, further including a transceiver or an antenna coupled to the at least one processor.

Aspect 21 is an apparatus for wireless communication at a device including means for implementing any of aspects 1 to 18.

Aspect 22 is a computer-readable medium (e.g., a non-transitory computer-readable medium) storing computer executable code, where the code when executed by a processor causes the processor to implement any of aspects 1 to 18.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor is configured to:
determine a time division duplex (TDD) frame repetition unit for a non-terrestrial network (NTN) cell, wherein the TDD frame repetition unit specifies a TDD frame structure spanning multiple radio frames within a repetition period;
monitor, based on the TDD frame repetition unit, at least one signal, of a set of signals, associated with cell acquisition for Narrowband-Internet of Things (NB-IoT) over the NTN cell; and
communicate with the NTN cell based on the at least one monitored signal associated with the cell acquisition.

2. The apparatus of claim 1, wherein the set of signals associated with the cell acquisition comprises one or more of a set of narrowband primary synchronization signals (NPSSs), a set of narrowband secondary synchronization signals (NSSSs), a narrowband physical broadcast channel (NPBCH), or a system information block (SIB).

3. The apparatus of claim 2, wherein the TDD frame repetition unit is repeated with a first periodicity and comprises a first repeating sub-unit spanning multiple radio frames associated with uplink (UL) resources and a second repeating sub-unit spanning multiple radio frames associated with downlink (DL) resources, wherein one or more physical layer attributes of the set of signals is associated with the TDD frame repetition unit, and wherein the one or more physical layer attributes comprise a first mapping to resources associated with the second repeating sub-unit.

4. The apparatus of claim 3, wherein a time period between a first NPSS in the set of NPSSs and an adjacent NPSS in the set of NPSSs within the second repeating sub-unit is shorter than one frame.

5. The apparatus of claim 3, wherein the set of NSSSs comprises one or more NSSSs that are transmitted within each second repeating sub-unit.

6. The apparatus of claim 5, wherein each NSSS among the one or more NSSSs is associated with a corresponding cyclic shift in a set of cyclic shifts, wherein the corresponding cyclic shift indicates a position in time within the second repeating sub-unit.

7. The apparatus of claim 6, wherein the set of cyclic shifts comprises four cyclic shifts, wherein at least one position in time of an NSSS within the second repeating sub-unit is associated with a plurality of cyclic shifts from among the set of cyclic shifts, and wherein the plurality of cyclic shifts is used to indicate other information.

8. The apparatus of claim 3, wherein an NPBCH sub-block of an NPBCH is transmitted in the second repeating sub-unit.

9. The apparatus of claim 8, wherein a transmission time interval (TTI) associated with the NPBCH is associated with the TDD frame repetition unit, wherein a second periodicity associated with an NBPCH sub-block of the NPBCH is equal to the first periodicity, and wherein the NPBCH sub-block is repeated a plurality of times over a plurality of TDD frame repetition units spanning the TTI.

10. The apparatus of claim 9, wherein a starting frame for mapping the NPBCH to a resource is based on at least one of:
a number of radio frames associated with at least one of the plurality of TDD frame repetition units, or the first periodicity; or
a location of the starting frame within the second repeating sub-unit.

11. The apparatus of claim 9, wherein a scrambling sequence re-initialization associated with the NPBCH is based on at least one of:
a number of radio frames associated with at least one of the plurality of TDD frame repetition units, or the first periodicity; or
a location of a starting frame within the second repeating sub-unit.

12. The apparatus of claim 9, wherein a system frame number (SFN) indicated in the NPBCH signaling indicates the SFN via a set of three most significant bits (MSBs) of a 10-bit SFN that are common to frames transmitted within the TTI, and wherein a fixed value is used to indicate at least a fourth MSB of the 10-bit SFN that is not common to the frames transmitted within the TTI.

13. The apparatus of claim 9, wherein a system frame number (SFN) associated with the NTN cell resets at a first time that exceeds a maximum time duration associated with a 10-bit SFN by a first duration, wherein the first duration is a period without scheduled communications from the NTN cell, and wherein the first duration is less than the first periodicity.

14. The apparatus of claim 9, wherein an additional index is signaled to identify a set of frames numbered based on a 10-bit system frame number (SFN) within a plurality of consecutive sets of frames numbered based on the 10-bit SFN.

15. The apparatus of claim 14, wherein the additional index of the set of frames within the plurality of consecutive sets of frames is indicated via one of:
a first set of bits in a master information block;
a second set of bits in a cell identifier field associated with a NSSS; or
a combination of a third set of bits in the cell identifier field associated with the NSSS and a cyclic shift value associated with the NSSS.

16. The apparatus of claim 3, wherein a set of SIBs specific to the NTN cell is transmitted within each second repeating sub-unit.

17. The apparatus of claim 16, wherein the set of SIBs comprises:
a first type of SIB scheduled based on a known configuration; and
one or more additional SIBs scheduled based on parameters indicated in the first type of SIB, wherein the parameters comprise one or more of a window length, a periodicity, and a repetition pattern specific to the NTN cell.

18. The apparatus of claim 1, further comprising at least one of a transceiver or an antenna coupled to the at least one processor, wherein to communicate with the NTN cell based on the at least one monitored signal, the at least one processor is further configured to transmit, via at least one of the transceiver or the antenna, an indication based on the at least one monitored signal.

19. A method of wireless communication at a user equipment (UE) comprising:
determining a time division duplex (TDD) frame repetition unit for a non-terrestrial network (NTN) cell, wherein the TDD frame repetition unit specifies a TDD frame structure spanning multiple radio frames within a repetition period;
monitoring, based on the TDD frame repetition unit, at least one signal, of a set of signals, associated with cell acquisition for Narrowband-Internet of Things (NB-IoT) over the NTN cell; and
communicating with the NTN cell based on the at least one monitored signal associated with the cell acquisition.

20. A computer-readable medium storing computer executable code, the code when executed by a processor causes the processor to:
determine a time division duplex (TDD) frame repetition unit for a non-terrestrial network (NTN) cell, wherein the TDD frame repetition unit specifies a TDD frame structure spanning multiple radio frames within a repetition period;
monitor, based on the TDD frame repetition unit, at least one signal, of a set of signals, associated with cell acquisition for Narrowband-Internet of Things (NB-IoT) over the NTN cell; and
communicate with the NTN cell based on the at least one monitored signal associated with the cell acquisition.
